(19) United States
(12) Patent Application Publication
(10) Pub. No.: US 2018/0194205 A1
(43) Pub. Date: Jul. 12, 2018

(54) WINDOW LIFT OPERATED BY STRUCTURAL CABLES FOR VEHICLE DOORS

(71) Applicant: GRUPO ANTOLÍN-INGENIERÍA, S. A., Burgos (ES)

(72) Inventors: Félix NEBREDA DE LA IGLESIA, Burgos (ES); Fernando REVILLA LÓPEZ, Burgos (ES)

(73) Assignee: GRUPO ANTOLÍN-INGENIERÍA, S. A., Burgos (ES)

(21) Appl. No.: 15/742,139

(22) PCT Filed: Jul. 6, 2015
(86) PCT No.: PCT/ES2015/070523

§ 371 Date: Jan. 5, 2018

(51) Int. Cl. B60J 5/04; E05D 15/16

(52) U.S. Cl. CPC B60J 5/0416; E05D 15/165; E05Y 2900/55; E05Y 2201/654; E05Y 2900/531; E05Y 2201/684

(57) ABSTRACT

Structural cable window lifter for vehicle doors, specifically a double guide rail structural cable window lifter that incorporates additional functional components such as the attachment means for the inner door handle, such that in an assembled position on the structure of the vehicle door the structural cable window lifter and the decorative door panel are connected through said inner door handle. Said structural cable window lifter comprises a strong structure that supports and transmits the loads generated during the operation of the window lifter, and/or the interior handle of the door, on the door structure through the guide rails, which are the only components of the structural cable window lifter joined to said door structure.

### FIELD OF THE INVENTION

The present invention relates to a structural cable window lifter for vehicle doors, specifically a cable window lifter with a double structural guide rail incorporating other functional components such as the attachment means for the inner door handle, such that in a mounted position on the structure of the vehicle door, the structural cable window lifter and the door decorative panel are connected through said inner door handle.

Said structural cable window lifter comprises a strong structure that supports and transmits the loads generated during the operation of the window lifter, and/or the inner door handle, on the door structure through the guide rails, which are the only components of the structural cable window lifter joined to said door structure.

### BACKGROUND OF THE INVENTION

One of the most important objectives when designing the various components of a vehicle is reducing weight.

Consequently, this is one of the problems to address when designing vehicle doors, the weight reduction being more advantageous in doors with large dimensions.

One of the ways to reduce the weight of the door is to eliminate the metal sheet configuring the central part of the inner skin of the door structure that is closest to the interior of the vehicle, the structural importance thereof is smaller than that of the rest of the surface configuring the inner skin, resulting in an inner skin with a large central opening.

This weight reduction results in less space being available to attach the various functional elements that form part of the door and which require the presence of a strong structure that can withstand the loads generated during the use of the door, such as to attach the interior handle of the door.

One of the solutions for compensating said lack of space is using other functional components common in vehicle doors to turn them into structural components that can fulfill more than one function on a single support, such that they also support and transmit the loads generated during the use of said functional components on the door structure.

Specifically, one of the common functional components is the window lifter and, in the specific case of doors with large dimensions, a double rail cable window lifter represents an economic solution.

In addition, the use of a plastic material to configure a structure window lifter that also incorporates other functional components allows integrating components or parts thereof on the same, thereby simplifying the assembly process. In this way, the solution using a double rail cable window lifter made of plastic is even more economical.

As part of the solution one possible configuration is connecting the two guide rails to each other, such as through a third component forming a single part. In this case specifically the third component can withstand and transmit the loads derived from the operation of the functional elements attached to it to the door structure.

A known example showing a structural window lifter is patent WO2012056137.

In this case the window lifter comprises two guide rails joined to the door structure and a structural element to which are attached among other elements the window lifter driving means and the inner door handle, wherein said structural element connects the guide rails and, as these, is also joined to the door structure.

Therefore, in this specific case the structural element joined to the structure of the door withstands and transmits directly the loads generated by the use of the inner door handle on the door structure.

However, in cases in which said structural element is not connected directly to the door structure but instead is connected only through the window lifter guide rails, the loads generated by tightening the cable that connects one of the upper redirection means placed on the guide rails and the cable winding drum connected to the driving means, which is the most unfavorable segment of the cable path with regard to generation of loads due to the weight of the window during the window raising operation, results in a change in the distance that separates said redirection means and the cable winding drum during the operation of the window lifter, thereby deforming the window lifter.

This phenomenon becomes a greater problem if the window lifter and the door panel are joined by the inner door handle, such that said window lifter deformations are transmitted to the door panel accessible to the occupant, who can perceive the deformations of the window lifter through said door panel.

In view of the above, the subject matter of the invention relates to a structural cable window lifter for large doors which, in addition to allowing reducing the weight of the vehicle door in an economic manner, allows integrating the attachments of the door handle without the vehicle occupant perceiving the deformations made in the structural cable window lifter through the door panel.

### DESCRIPTION OF THE INVENTION

The present invention is established and characterized in the independent claims, while the dependent claims describe additional features thereof.

Firstly, the configuration of the invention allows reducing the weight of the door without changing the usual position of any of the functional components characteristic of a conventional vehicle door, and therefore without changing the design of the interior of the vehicle and specifically of the door panel.

In addition, the presence of strong elements with structural continuity from the area where the loads are generated to the area where these are transmitted to the door structure through the guide rails allows providing an attachment area for the inner door handle that can withstand and transmit said loads to the door structure.

In addition, the configuration of the invention allows withstanding and resisting the loads generated by the cable tension in the most unfavorable segment of the kinematic chain of the window lifter, maintaining the separation between the ends of said most unfavorable cable segment, thereby preventing the deformation of the structural cable window lifter and consequently preventing the movement of the attachment area of the inner door handle.

In this way the vehicle occupant will not perceive any anomalous movement of the door panel resulting from it being connected to the structural cable window lifter through said inner door handle.

Finally, the selection of plastic material to manufacture a structural double guide rail cable window lifter represents an economic solution, as in addition to being able to perform the functions characteristic of a window lifter when the window has large dimensions, also allows integrating components of parts thereof, simplifying the mounting process for the same.

### DESCRIPTION OF THE DRAWINGS

The present specification is completed by a set of figures illustrating a preferred embodiment, in no way meant to limit the invention.

FIG. 1 shows a front view of the structural cable window lifter and the kinematic chain thereof, indication section AA.

FIG. 2 shows a cross-sectional view along AA as represented in FIG. 1 of the second structural element.

FIG. 3 shows an exploded view of a vehicle door, representing the door structure with the door panel and the structural cable window lifter, connected through the inner door handle.

### DETAILED DESCRIPTION OF THE INVENTION

Double guide rail cable window lifters are well known in the prior art. They comprise two approximately parallel guide rails that guide carriages joined to the window and pulled along said guide rails by a cable, which in turn consists of several cable segments, redirected at the ends of the guide rails and driven by driving means placed between the guide rails, which comprise a cable winding drum, that make the window move up and down.

Specifically, in the present invention the cable (10) meant to pull the window works under tension in at least one segment (10.1) thereof, particularly in segment (10.1) connecting the cable redirection means (8.1) located on the upper end of the first guide rail (2) and the cable winding drum (7.1) that forms part of the winding means (7).

In this cable segment (10.1) is where the highest loads are generated compared to those generated in the remaining cable segments (10) that form the window lifter kinematic chain. These loads tend to join the positions of each upper redirection means and the cable winding drum connected to the driving means, thereby deforming the structural cable window lifter.

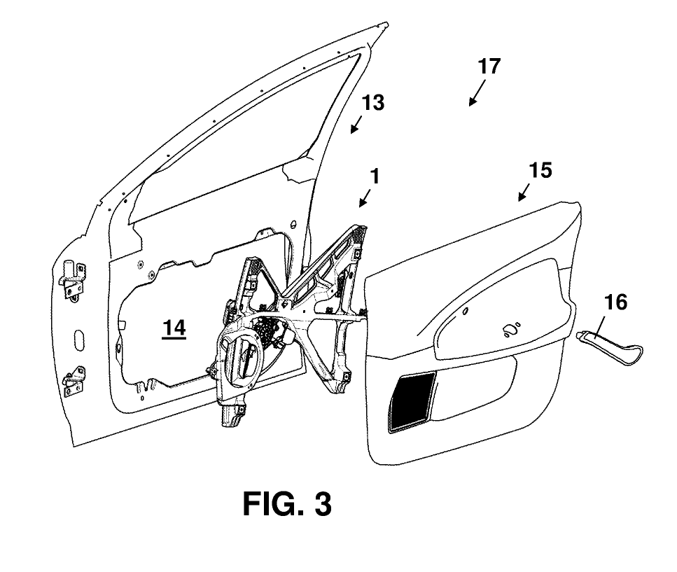

As shown in FIG. 3, both the structural cable window lifter (1) and the door panel (15) that provides an aesthetic appearance to the door (17) are attached to a structure of the vehicle door (13) which has a large central opening (14), in this case with the specific feature that the structural cable window lifter (1) and the door panel (15) are connected through the inner door handle (16), such that the vehicle occupant perceives the deformations made in the structural cable window lifter (1) through the door panel (15), due to the loads exerted on said more unfavorable cable segment (10.1).

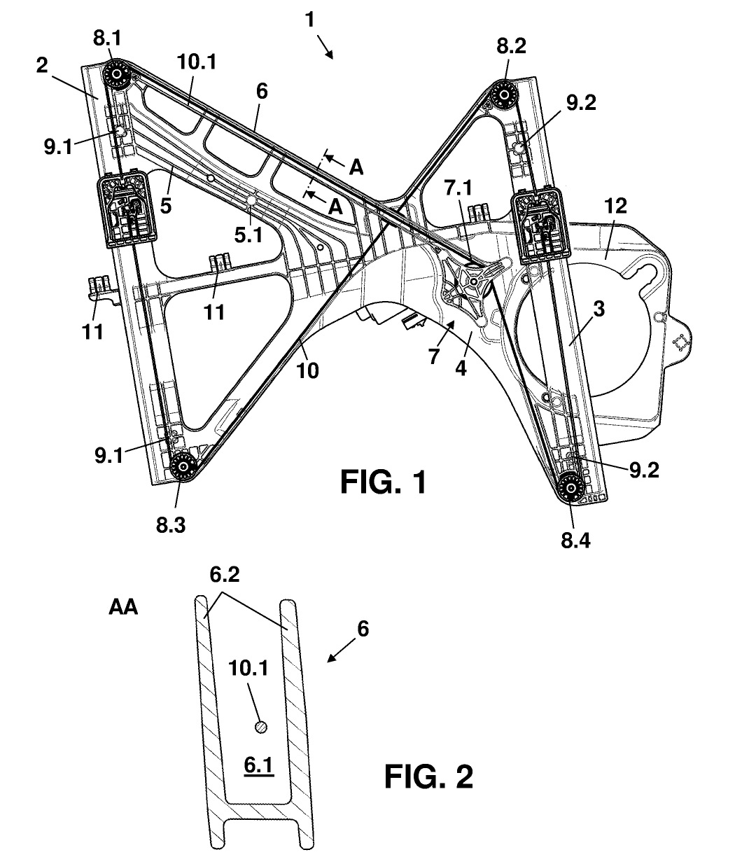

Specifically, the structural cable window lifter (1) of the invention represented in FIG. 1 comprises the elements described below.

A first guide rail (2) that comprises first cable redirection means (8.1) placed at the upper end thereof, second cable redirection means (8.3) placed at the lower end thereof and first attachment means (9.1) for the first guide rail (2) to the vehicle door.

A second guide rail (3) comprising third and fourth cable redirection means (8.2, 8.4), located respectively on the upper and lower ends, and second attachment means (9.2) for the second guide rail (3) to the structure of the vehicle door (13).

Wherein the position corresponding to the upper and lower ends of the guide rails refers to the position of said ends once the structural cable window lifter (1) has been attached to the structure of the vehicle door (13).

Moreover, the structural cable window lifter (1) comprises a first element (4) that connects said first and second guide rail (2, 3) which comprises a continuous structural portion (5) provided with attachment means (5.1) for the inner door handle (16), such that said structural portion (5) has structural continuity from the inner door handle (16) where the loads generated by using the inner door handle (16) are generated, to the guide rails (2, 3) where the loads are transmitted to the structure of the vehicle door (13) through the attachment means (9.1, 9.2). That is, the structural portion (5) has structural continuity because it can withstand and transmit the loads from the inner door handle (16) to the guide rails (2,3).

As shown in FIG. 1, in a specific case the structural behavior of the structural portion (5) of the first element (4) is determined by a ribbed shape extending continuously from the first guide rail (2) to the second guide rail (3), passing through the attachment means (5.1) of the inner door handle (16).

In addition, said structural portion (5) can have other geometrical configurations, as well as other constructive solutions, to ensure the structural performance thereof, such as a configuration with a cross section providing a greater moment of inertial along the direction of the loads generated by using the inner door handle, or an increased thickness along the length thereof, or include additional reinforcement materials such as mats of a fibrous material such as fiber glass, blended with plastic material.

Furthermore, according to a specific embodiment of the invention not represented in the figures, the first element (4) couple be completely structural and therefore coincide with the structural portion (5).

In addition, the structural cable window lifter (1) includes driving means (7) that comprise a cable winding drum (7.1), placed between the first guide rail (2) and the second guide rail (3) and connected to the first element (4), either on the structural portion (5) or on a non-structural portion thereof.

The structural cable window lifter (1) also comprises a second continuous structural element (6) that connects the first guide rail (2) to the first element (4) and runs along a segment (10.1) of the cable (10) placed between the first redirection means (8.1) and the cable winding drum (7.1), this continuous structural element (6) being able to maintain the distance between the first redirection means (8.1) and the cable winding drum (7.1) constant during the window raising and lowering movements.

As shown in the cross-sectional view of FIG. 2, in a specific case the structural performance of the second structural element (6) is determined by a shape thereof configured by two walls (6.2) that define a cavity (6.1) which houses the cable segment (10.1) that runs from the first cable redirection means (8.1) to the cable winding drum (7.1), and wherein said walls (6.2) project perpendicular to the main surface of the structural cable window lifter (1), in turn defined by the shape of the guide rails (2, 3) defining a U-shaped section.

In this way, the cross-section of the second structural element (6) has a greater moment of inertia along the direction of the loads generated due to the tension of the cable (10) in said segment (10.1) that it must withstand.

In addition, said second structural element (6) could present other geometrical configurations, as well as other constructive solutions in order to ensure the structural performance thereof, such as a ribbed configuration or an increased thickness thereof along its length, or comprise additional reinforcement materials such as mats of a fibrous material such as fiber glass, blended with plastic material.

Consequently, the configuration of the structural cable window lifter (1) of the invention is established by a structural assembly configured as a single piece of plastic material comprising the first guide rail (2), the second guide rail (3), the first element (4) with a structural portion (5) and the second structural element (6).

The minimum components comprising the structural cable window lifter (1) of the invention have been described and enumerated. However, according to other embodiments the structural cable window lifter (1) could integrate other components, such as clips (11) for attaching and guiding the electrical wire or means for attaching a speaker (12), as well as other non-structural plastic portions to support said components (11, 12), and can include other components such as the electrical wire, impact absorption means, a lock, etc.

1. Structural cable window lifter for vehicle doors comprising:
a first guide rail (2) comprising first cable redirection means (8.1) on the upper end thereof, second cable redirection means (8.3), and first attachment means (9.1) for the first guide rail (2) to a structure of the vehicle door (13);
a second guide rail (3) comprising third and fourth cable redirection means (8.2, 8.4), and second attachment means (9.2) for the second guide rail (3) to the structure of the vehicle door (13);
a first element (4) connecting said first and second guide rails (2,3) comprising a structural portion (5) that includes attachment means (5.1) for the inner door handle (16), such that said structural portion (5) has structural continuity from the inner door handle (16) where the loads resulting from the use of said inner door handle (16) are generated, to the guide rails (2,3) where the loads are transmitted to the structure of the vehicle door (13) through the attachment means (9.1, 9.2);
driving means (7) comprising a cable winding drum (7.1) placed between the first guide rail (2) and the second guide rail (3) and connected to the first element (4);
a second continuous structural element (6) that joins the first guide rail (2) to the first element (4), and runs along a segment (10.1) of the cable (10) located between the first redirection means (8.1) and the cable winding drum (7.1), said continuous structural element (6) being able to maintain the distance between the first redirection means (8.1) and the cable winding drum (7.1) constant during the window raising and lowering movements;
wherein the first guide rail (2), the second guide rail (3), the first element (4) with a structural portion (5) and the second structural element (6) form a structural assembly made of a single piece of plastic material.

2. Structural cable window lifter for vehicle doors according to claim 1, wherein the first element (4) and the structural portion (5) of the first element (4) coincide.

3. Structural cable window lifter for vehicle doors according to claim 1 wherein the structural portion (5) of the element (4) has a ribbed geometry that runs continuously from the first guide rail (2) to the second guide rail (3).

4. Structural cable window lifter for vehicle doors according to claim 1 wherein the second structural element (5) has a geometry configured by two walls (5.2) that define a cavity (6.1) that houses the segment (10.1) of the cable (10) reaching from the first cable redirection means (8.1) to the cable winding drum (7.1), and wherein said walls (6.2) extend perpendicularly with respect to the main surface of the structural cable window lifter (1) defined in turn by the geometry of the guide rails (2, 3), defining a U-shaped section.

5. Structural cable window lifter for vehicle doors according to claim 1 comprising additional integrated components such as clips (11) for attaching and guiding a electrical wire, means for attaching a speaker (12), or other non-structural plastic portions to support said components (11, 12).
